(19) United States
(12) Patent Application Publication
(10) Pub. No.: US 2011/0030733 A1
(43) Pub. Date: Feb. 10, 2011

(54) POST SPUTTER WASH PROCESS MODULE

(76) Inventors: Dave Frost, Scotts Valley, CA (US); Mike Rogowski, Scotts Valley, CA (US); Yassin Mehmandoust, Scotts Valley, CA (US); Tom Poplawski, Scotts Valley, CA (US); Stan Young, Scotts Valley, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/139,383

(22) Filed: Jun. 13, 2008

Related U.S. Application Data
(60) Provisional application No. 60/944,091, filed on Jun. 14, 2007.

(51) Int. Cl. B08B 3/10; B08B 13/00

(52) U.S. Cl. 134/19; 134/33; 134/26; 134/105; 134/63; 134/107

(57) ABSTRACT

In one embodiment, a method for cleaning a substrate in a cleaning module is disclosed. The method includes an operation that receives the substrate into a first level of the cleaning module. In another operation, the substrate is spun while contemporaneously applying a cleaning fluid to top and bottom surfaces of the substrate. In yet another operation, the substrate is spun at a second level of the cleaning module. The method also includes an operation to dry the substrate in an enclosed cavity at a third level of the cleaning module.

### CLAIM OF PRIORITY

This application claims priority from U.S. provisional application for patent No. 60/944,091, filed on Jun. 14, 2007, and entitled “POST SPUTTER WASH PROCESS MODULE”, the provisional application is hereby incorporated by reference.

### BACKGROUND

Cleaning operations are becoming more critical during the manufacture of semiconductor wafers and magnetic discs for storage apparatuses. Due to the changing nature of the manufacturing operations and the continuing quest to further reduce feature sizes and be able to fit more data onto a magnetic substrate, the batch cleaning processes previously used are becoming more ineffective to obtain the desired level of cleaning necessary to ensure proper cleaning of a substrate. However, throughput remains an important criteria during the processing operation and while batch operations may be desirable from a throughput point of view, the shortcomings of the batch operation and associated cleaning effectiveness provided by these operations outweighs any throughput advantages.

Accordingly, there is a need to provide single wafer cleaning process and system that is viable from a throughput point of view and will enable more efficient cleaning of the substrates.

### SUMMARY

In one embodiment, a method for cleaning a substrate in a cleaning module is disclosed. The method includes an operation that receives the substrate into a first level of the cleaning module. In another operation, the substrate is spun while contemporaneously applying a cleaning fluid to top and bottom surfaces of the substrate. In yet another operation, the substrate is spun at a second level of the cleaning module. The method also includes an operation to dry the substrate in an enclosed cavity at a third level of the cleaning module.

In another embodiment, a cleaning module is disclosed. The cleaning module includes an enclosure with multiple cleaning levels. The enclosure includes a lower inner enclosure configured to accommodate a wet cleaning operation. Also included within the cleaning module is a middle partial enclosure wherein a spinning operation of a substrate being cleaned is performed. The enclosure also includes an upper enclosure configured to close around the substrate, the upper enclosure configured to dry the substrate at an elevated temperature.

In still another embodiment, a cleaning apparatus for a substrate is disclosed. The cleaning apparatus including a first chamber configured to apply a rinse agent to the substrate and a second chamber configured to perform an ambient temperature drying operation. The cleaning apparatus also includes a third chamber configured to perform an elevated temperature drying operation.

In yet another embodiment, a substrate cleaned by process operations is disclosed. The process includes operations that secure the substrate to a collet affixed to a spindle in order to spin the substrate while a cleaning fluid is applied to top and bottom surfaces of substrate. In another operation the spindle is extended to transition the substrate from a first chamber to a second chamber of the substrate cleaning assembly. Once within the second chamber of the substrate cleaning assembly, the process also includes operations to spin the substrate. In other operations, the spindle is extended to transition the substrate from the second chamber into a third chamber where the substrate is heated while spinning.

Other aspects and advantages of the invention will become apparent from the following detailed description, taken in conjunction with the accompanying drawings, illustrating by way of example the principles of the invention.

### BRIEF DESCRIPTION OF THE DRAWINGS

Aspects of the present invention will become apparent from the following detailed description, taken in conjunction with the accompanying drawings, illustrating by way of example the principles of the invention.

FIG. 1 is a simplified schematic diagram illustrating a post sputter wash process module in accordance with one embodiment of the invention.

FIGS. 2A, 2A-1 and 2B are schematic diagram illustrating the post sputter wash process module of FIG. 1 in further detail in accordance with one embodiment of the invention.

FIG. 2C is a more detailed view of an exhaust section for the post sputter wash process module, in accordance with one embodiment of the present invention.

FIG. 3A is a simplified schematic diagram with the enclosure of the first level of the post sputter wash process module removed in order to view further details of the module in accordance with one embodiment of the invention.

FIGS. 3B-3D are additional simplified schematics illustrating further details of the enclosure at the first level in accordance with one embodiment of the present invention.

FIG. 4 is a bottom perspective view of the post sputter wash process module in accordance with one embodiment of the invention.

FIG. 5 is a cross sectional diagram illustrating a cross section of the post sputter wash process module in accordance with one embodiment of the invention.

FIG. 6 is a simplified schematic diagram illustrating a portion of the heated drying stage in accordance with one embodiment of the invention.

FIG. 7 is a simplified schematic diagram providing a perspective view of the enclosure for the final cleaning stage of the post sputter wash process module in accordance with one embodiment of the invention.

FIG. 8A is a simplified schematic diagram illustrating the perspective view of the enclosure for heating and drying the substrate in the post sputter wash process module in accordance with one embodiment of the invention.

FIG. 8B is a top view of another embodiment of the enclosure for heating and drying the substrate in the post sputter wash process module in accordance with one embodiment of the invention.

FIG. 9 is a simplified schematic diagram illustrating a rear perspective view of the enclosure for the heated fluid drying of the third stage of the post sputter wash process module in accordance with one embodiment of the invention.

FIGS. 10 through 12 provide alternative views of the final stage for the post sputter wash process module in accordance with one embodiment of the invention.

FIG. 13 is a simplified schematic diagram illustrating an alternative embodiment of the invention where the three stage cleaner described herein includes a bottom port and a top port.

FIG. 14 illustrates a simplified schematic diagram of the substrate being positioned into the first cleaning stage for a rinse operation in accordance with one embodiment of the invention.

FIG. 15 illustrates a next position from FIG. 14 in which the housing has further compressed in order to provide the spin dry position in the next level of cleaning.

FIG. 16 is a simplified schematic diagram illustrating the further retraction of the bellows so that the housing drops from the position of FIG. 15 in order for the hot drying process to proceed.

### DETAILED DESCRIPTION

The embodiments described herein provide for a method and system in which a substrate is cleaned within a single module. The substrate is moved vertically through a transitioning spindle that provides a cascade cleaning effect in that the substrate moves from a less clean environment initially to a cleaner environment in the final stage of the cleaning. In one embodiment, the post sputter wash process module described herein is a three-stage cleaning module in which a first stage clean is performed in a wet environment, such as a spin, rinse and dry operation. The second level of cleaning is a spin process to further dry off the substrate. In the third level of cleaning, heated fluid and/or a heated environment is provided within an encapsulated environment in order to remove a final monolayer of water or cleaning fluid remaining on the surfaces, wherein the top, bottom and edge surfaces of the substrate are exposed to the heated fluid.

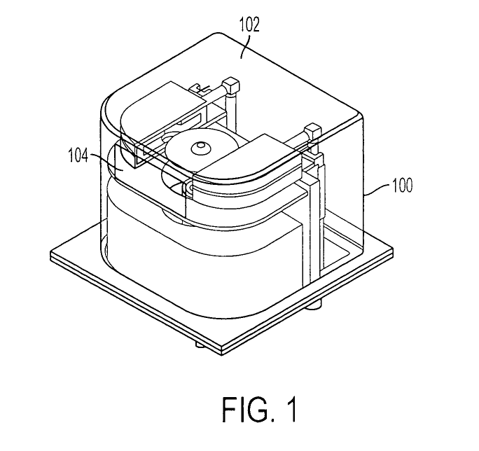

FIG. 1 is a simplified schematic diagram illustrating a post sputter wash process module in accordance with one embodiment of the invention. Post sputter wash process module 100 is enclosed with enclosure 102 having an input slot 104 available for movement of a disk for input and output from the post sputter wash module. In one embodiment, post sputter wash module 100 is a three-station module in which a spindle moves a substrate to be washed and dried to the different process module levels within the post sputter wash process module. Thus, a robot or end effector may place a substrate into post sputter wash process module 100 through input slot 104. In one embodiment, the end effector or robot may be a dual shuttle vacuum edge gripper that will place a substrate into the post sputter wash process module and remove a substrate from the module. That is, once a substrate is finished, the end effector will deliver another substrate for processing after picking up a substrate that has been finished. In one embodiment, the substrates being processed are magnetic discs used for hard drives that have been processed with an underlayer, magnetic layers, and a carbon overcoat. Accordingly, post sputter wash process module 100 will help clean the magnetic disk after the carbon overcoat process in order to clean and prepare the disc for further processing in one embodiment. Of course, the cleaning module defined herein may be applied to any suitable cleaning process and is not limited to post sputter processes.

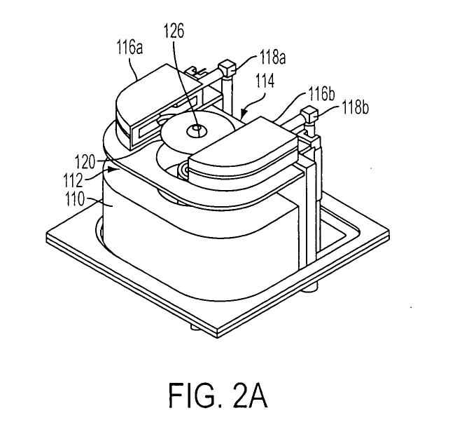

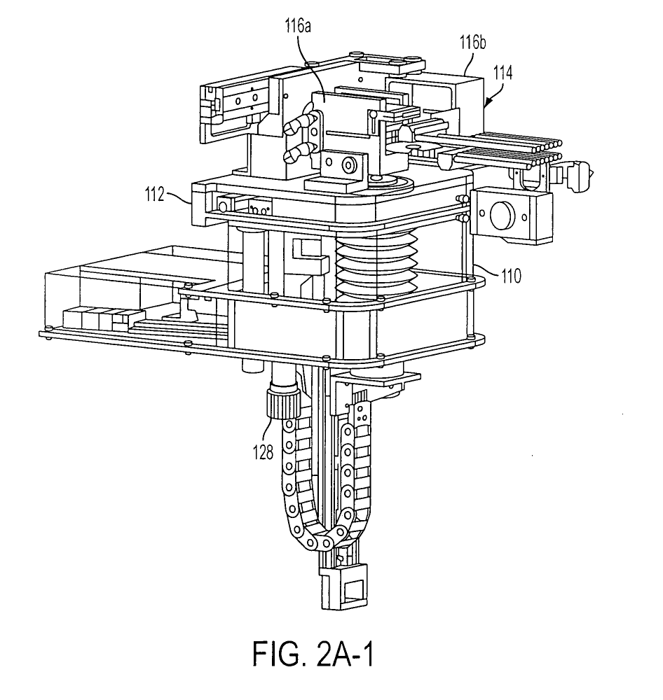

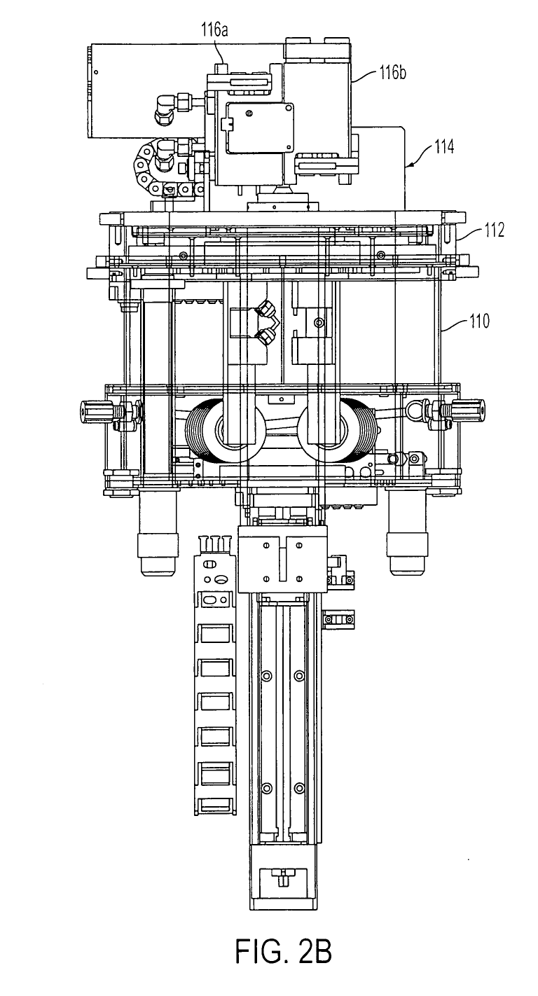

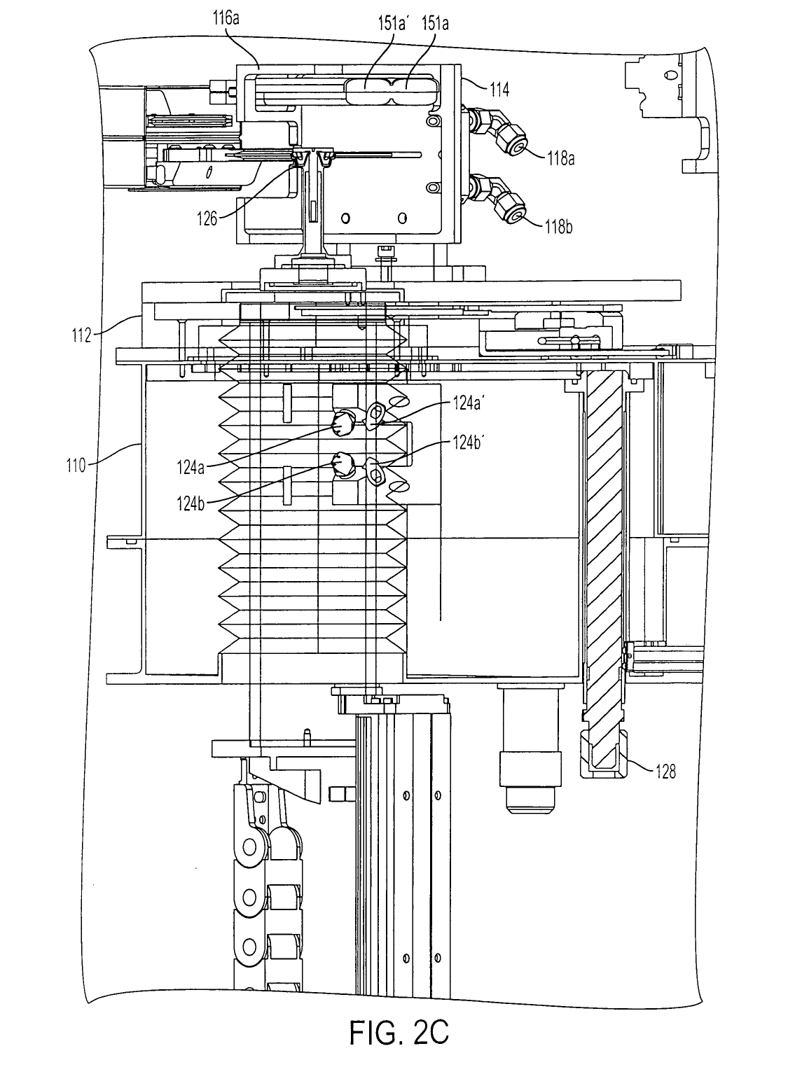

FIGS. 2A, 2A-1 and 2B are schematic diagram illustrating the post sputter wash process module of FIG. 1 in further detail in accordance with one embodiment of the invention. The post sputter wash process module of FIG. 2A and FIG. 2A-1 has cover 102 removed in order to view the components within the module more clearly. Post sputter wash process module includes a secondary enclosure 110 enclosing a first level of cleaning within the process module. The second level of cleaning is provided above the first level as indicated by section 112. A third and final level of cleaning is provided above the second level and is indicated by section 114.

Enclosure 110 encloses an area where the substrate undergoes a spin, rinse and dry process in accordance with one embodiment of the invention. Within enclosure 110, multiple nozzles provide a cleaning fluid such as deionized water to the top and bottom surfaces of the substrate as the substrate is spinning around its axis. The nozzles providing the fluid to the surfaces of the substrate are retractable in one embodiment, in order for the substrate to move in a vertical direction past the nozzles once the spin, rinse and dry processing has completed. In one embodiment, enclosure 110 is conically shaped to prevent fluid from the process from entering the second level. In another embodiment, a movable partition can isolate the interior of section 112 from the fluid and vaporized fluid within enclosure 110. In such an embodiment, during the spin, rinse and dry operation within the enclosure 110 the partition is closed. The partition can be opened upon completion of the spin, rinse and dry operation to allow a substrate to be transitioned to section 112. In one embodiment, after the substrate has been transitioned into section 112 the partition can be closed in order to isolate section 112 from enclosure 110. Conversely, in another embodiment, after the substrate has transitioned into section 112 the partition can remain open.

Upon completion of the spin, rinse and dry process, substrate 120 is moved from the first level enclosed by enclosure 110 to the second level indicated by section 112 of FIGS. 2A, 2A-1 and 2B. In one embodiment, as the substrate is transitioned from enclosure 110 to section 112 a vacuum is drawn through enclosure 110 to minimize vaporized fluid transfer between the enclosure 110 and section 112. In section 112, the substrate is spun at a higher rate than the spinning during the spin, rinse and dry cycle in the first level. Spinning the substrate within section 112 assists in removing residual fluid remaining on the substrate. In one embodiment, the substrate spins at approximately 2000 rpm at the first level during the spin, rinse and dry operation. At the second level, the substrate will spin at a rate of approximately 10,000 rpm. One skilled in the art will appreciate that these rates of spinning are exemplary and not meant to be limiting as any suitable spin rates may be used. In one embodiment, the same spin rate may be used in the first level and the second level. In another embodiment, the level of spinning in the second level is greater than the level of spinning in the first level.

FIG. 2C is an exemplary illustration of a cross section of post sputter wash process module, in accordance with one embodiment of the present invention. When a substrate is within section 112 a vacuum may be applied to remove air within the section in order to prevent condensation of vaporized fluids on the surface of the substrate. In embodiments where the partition between section 112 and enclosure 110 remains open, the vacuum can be drawn through enclosure 110. In other embodiments where the partition is closed, section 112 can be configured with a vacuum exhaust 128 as illustrated in FIG. 2C. Upon completion of the spinning operation in the second level, the substrate is transitioned to a third level 114 where a heated drying operation is performed. In the heated drying operation, substrate 120 is spun within an enclosed cavity defined within enclosures 116a and 116b.

In FIG. 2A and FIG. 2A-1, enclosures 116a and 116b are illustrated in a retracted state so that substrate 120 may be transitioned to a position between enclosures 116a and 116b. In FIG. 2B, enclosures 116a and 116b are illustrated in a closed state. Upon transition of the substrate to the third level, enclosures 116a and 116b close in order to substantially isolate substrate 120 from the external environment. When enclosures 116a and 116b are closed, a heated drying operation is performed where substrate 120 spins while a heated fluid is provided into the cavity defined within enclosures 116a and 116b. The heated fluid is provided through fluid inlet ports 118a and 118b, respectively.

As illustrated in FIG. 2C, the substrate 120, supported by a collet 126 is within the third level 114. FIG. 2C also illustrates various methods that can be used to heat the cavity defined by enclosures 116 and 116b. In one embodiment, heating elements 151a and 151a′ can be used to elevate the temperature within enclosures 116a and 116b. In other embodiments, the cavity defined by enclosures 116a and 116b is heated using heated fluid provided through fluid inlet ports 118a and 118b. In additional embodiment, both heating elements 151a and 151a′ along with heated fluid can be used to elevate the temperature within the cavity defined by enclosures 116a and 116b.

Still referring to FIG. 2A, FIG. 2A-1 and FIG. 2B, substrate 120 is supported on a spindle by collet 126. Further details on collet 126 are provided below. In essence, collet 126 is configured to extend through a center hole of substrate 120 and grip the inner edges of the center hole of substrate 120. In one embodiment, collet 126 is an expanding collet that will expand to the diameter of the inner hole in order to grip substrate 120 to provide rotation within a plane. In another embodiment, substrate 120 spins approximately 8 to 10 seconds at each station, however, this residence time is exemplary and may be changed depending on the process or nature of the materials being cleaned within the post sputter wash process module.

In one embodiment, heated nitrogen is provided through inlets 118a and 118b to the inner cavity defined by enclosures 116a and 116b and eventually to the top and bottom surfaces of substrate 120 for the final cleaning process. In another embodiment, enclosures 116a and 116b include heating elements to further heat the fluid provided to the enclosures. For example, heated nitrogen is provided at a flow rate in a range of about 0.75-2.25 cubic feet per minute at about 150° C. to the inner cavity defined by enclosures 116a and 116b in one embodiment. The heated nitrogen may be further heated to about 250° C. within enclosures 116a and 116b through resistive heating elements or other suitable heating elements placed therein. One exemplary resistive heating element is a quartz lamp. In some embodiments, multiple resistive heating elements can be used in various physical configurations in order to apply heat to the top and bottom of the substrate while the substrate spins within the cavity defined by enclosures 116a and 116b.

In other embodiments, the heated drying operation is performed without the application of heated fluid and instead relies on resistive heating elements such as quartz lamps. It should be appreciated that, the enclosures 116a and 116b can be configured to allow light and heat emitted from the resistive heating elements to be directly exposed to the substrate. As illustrated in FIG. 2C the enclosure is configured so heating elements 151a and 151a′ can be positioned within the enclosure 116a. This configuration allows temperatures within the cavity defined by enclosures 116a and 116b to be rapidly elevated. In alternative embodiments, a substrate within the cavity defined by enclosures 116a and 116b is shielded from direct exposure from radiation from the heating elements 151a and 151a′ by a diffuser, disposed between the surfaces of the substrate and the resistive heating elements. This embodiment can be used to more evenly distribute heat through the cavity defined by enclosures 116a and 116 if the substrate is sensitive to drastic or rapid temperature fluctuations. The enclosures 116a and 116b may be configured to have multiple heating elements within, around, or a combination thereof, to apply heat to the top and bottom surfaces of the substrate while within the enclosures 116a and 116b. During the heated drying operation the temperature of the disk surface of the substrate is between a range of about 75° C.-175° C. where the substrate is a hard drive platter. However, the temperature range provided is exemplary and should not be considered limiting.

One skilled in the art will appreciate that the temperature within enclosures 116a and 116b may be monitored through a heat-sensing element placed therein, which provides feedback to a controller. The controller in turn may modulate the heating of the enclosures according to the sensed temperature. For example, the heating element may be a thermocouple connected to a computing device that provides feedback on controlling output of the heating elements within enclosures 116a and 116b. Upon completion of the heated drying process, the enclosures 116a and 116b are retracted back to an open position and an end effector will provide a new substrate onto the spindle after picking up the processed substrate. Of course, collet 126 will retract in order to enable the end effector to remove the processed substrate.

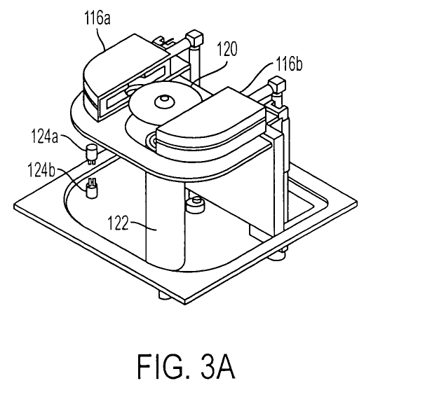

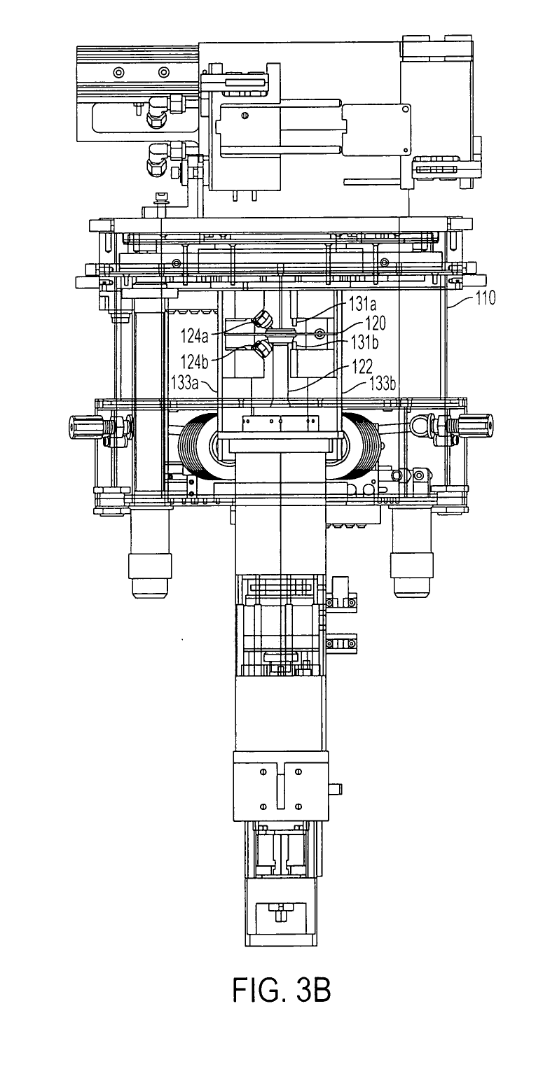

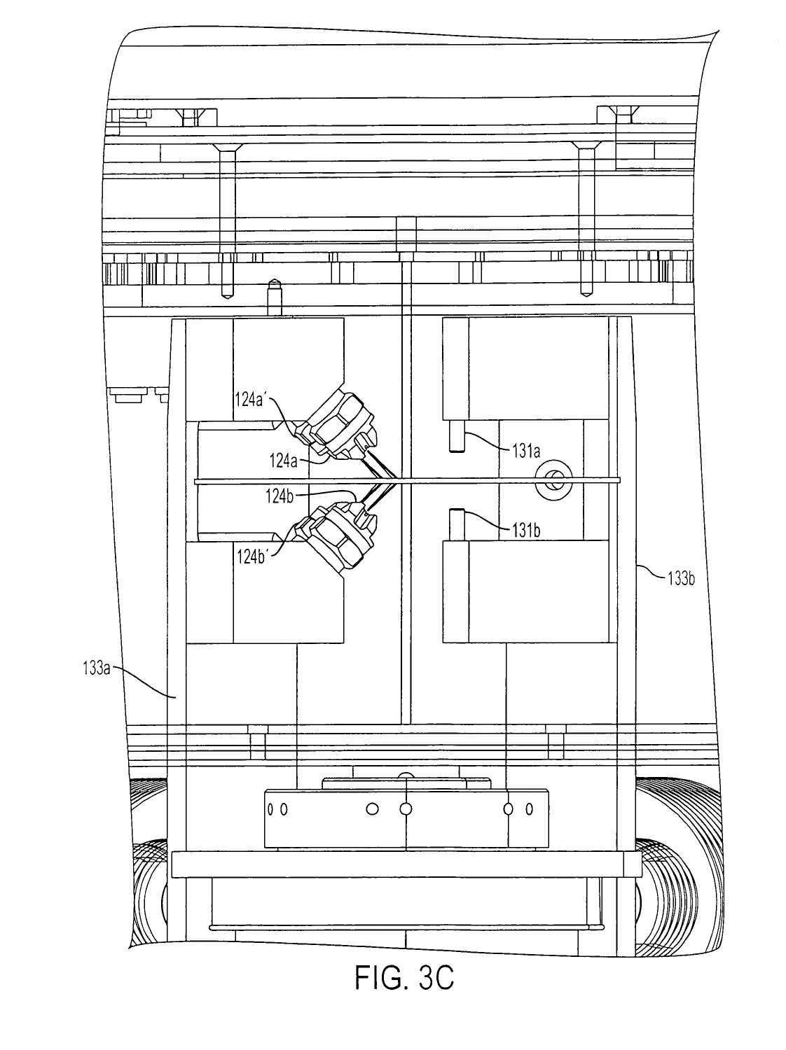

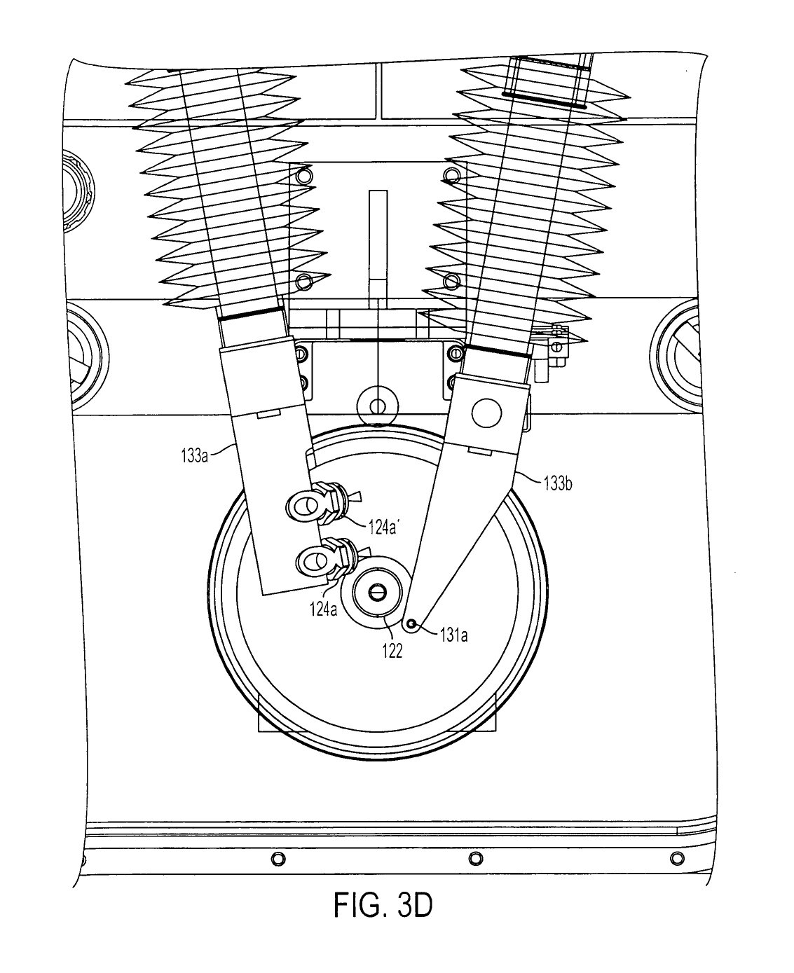

FIG. 3A is a simplified schematic diagram with the enclosure of the first level of the post sputter wash process module removed in order to view further details of the module in accordance with one embodiment of the invention. In FIG. 3A, enclosure 110 of FIG. 2A has been removed in order to view further details of the post sputter wash process module. As illustrated in FIG. 3A, spindle 122 will provide support and vertical translation for substrate 120. Nozzles 124a and 124b are provided to illustrate exemplary nozzles that may be used to spray cleaning fluid onto top and bottom surfaces of substrate 120 when the substrate is in the first cleaning level. It should be appreciated that in one embodiment, four nozzles are provided for each of the top and the bottom surfaces for a total of eight nozzles. Each pair of the nozzles would be supported on a retractable arm which is not shown. The retractable arm would move in and out similar to enclosures 116a and 116b in order to enable vertical movement of substrate 120 through spindle 122.

Spindle 122 of FIG. 3A will translate vertically through a spindle drive. A spindle drive may include a servomotor mounted to a holder on a linear slide. A bellows is provided around the spindle. In one embodiment, spindle 122 travels a vertical distance between the first level of cleaning and the third level of cleaning of about eight inches. Of course, the level of travel may vary depending on the processes and configuration of the post sputter wash process module and is exemplary and not meant to be limiting. The bellows enclosing spindle 122 is stainless steel in one embodiment. The bellows, while capable of expanding and retracting along with the vertical movement of spindle 122, prevents particulates being generated and emanating into the cleaning areas of the post sputter wash process module. One skilled in the art will appreciate that other mechanical means such as pneumatics, linear motors, and servomotors may be provided to vertically translate substrate 120. The examples provided may be integrated into the embodiments described herein but are not intended to be exhaustive of mechanical means to translate the substrate.

FIGS. 3B-3D are additional simplified schematics of the enclosure 110 at the first level in accordance with one embodiment of the present invention. Though not clearly visible in FIG. 3B, nozzles 124a′ and 124b′ can be see in FIGS. 3C and FIG. 3D. In FIGS. 3B and 3D the nozzles 124a,124a′, 124b and 124b′ along with fluid supply 131a and 131b is illustrated in close proximity to the spindle 122. The nozzles 124a, 124a′, 124b and 124b′ may be used to apply cleaning fluid onto top and bottom surfaces of substrate 120 when the substrate is in the first cleaning level. It should be appreciated that the cleaning fluid may be puddled or sprayed on the surface. In one embodiment, the nozzles 124a, 124a′, 124b, 124b′ are high-pressure spray nozzles. In another embodiment, additional nozzles (not shown) such as sonic nozzles can be used within the enclosure 110. The addition of sonic nozzles can allow acoutsic energy to remove contaminates in conjunction with fluid supplied through high-pressure nozzles. In still other embodiments, the nozzles 124a, 124a′, 124b, 124b′ can incorporate sonic capability so additional sonic specific nozzles are not required. It should be appreciated that the sonic capability can be supplied through an appropriate transducer. Additionally, fluid supply 131a and 131b can supply rinsing fluids onto top and bottom surfaces of the substrate 120. The number of nozzles and fluid supplies illustrated in FIG. 3B-3D should not be construed as limiting. The number of nozzles or fluid supplies for a post sputter wash process module can vary based on parameters such as, but not limited to the size of the substrate being cleaned, volumetric nozzle throughput, nozzle output geometry, and desired throughput module. In one embodiment, the nozzles 124a, 124a′, 124b and 124b′ are supported on retractable arm 133a while fluid supply 131a and 131b are supported on retractable arm 133b. In one embodiment, during cleaning operations the retractable arm 133a can be moved so the nozzles 124a,124a′, 124b and 124b′ are moved radially across the substrate. Similarly, in some embodiments rinsing fluid can be applied across the substrate by moving the retractable arm 133b radially across the substrate.

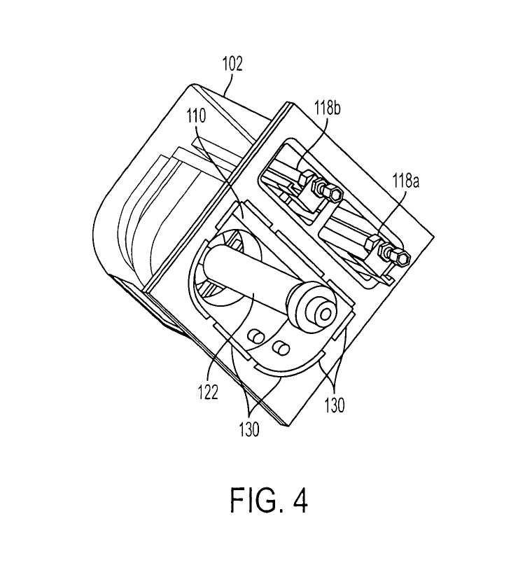

FIG. 4 is a bottom perspective view of the post sputter wash process module in accordance with one embodiment of the invention. The bottom view of FIG. 4 illustrates spindle 122 and the extensions for inlets 118a and 118b in accordance with one embodiment of the invention. In addition, slots 130 which are defined outside of enclosure 110 and inside enclosure 102, are provided for draining purposes and vacuum enablement. The cavity defined within enclosure 110 is illustrated and will house the wet spin rinse and dry operation. In this operation, the enclosure 110 maintains the fluid being sprayed and spun off the substrate within the enclosure cavity and will drain simply by the gravity process in one embodiment. Of course, vacuum may be applied to assist in removal of the liquid discharged from the cleaning operation in the first level. Slots 130 may also be used to capture any liquid provided from the cleaning operation of the second level as well as providing the vacuum in order to provide for evacuation of the heated fluid being input through the third level of cleaning. One skilled in the art will appreciate that a vacuum pump may be operably connected to a delivery inlet in order to provide vacuum to the cavity of enclosure 110, as well as provide vacuum through slots 130. Of course, a single vacuum pump may provide this feature with appropriate valving, or dedicated vacuum pumps may be provided for each flow path.

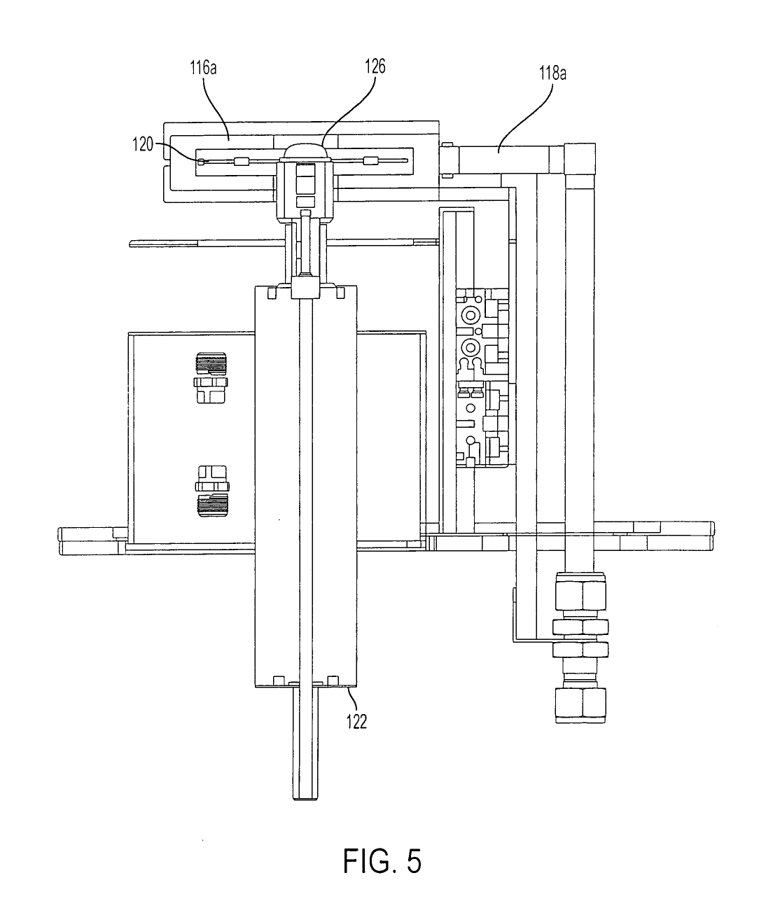

FIG. 5 is a cross sectional diagram illustrating a cross section of the post sputter wash process module in accordance with one embodiment of the invention. Within FIG. 5, further details of collet 126 are provided. Collet 126 includes a top cap which extends through the inner hole of discs 120. Spindle 122 is provided to rotate disc 120 at the various levels through the embodiments described above.

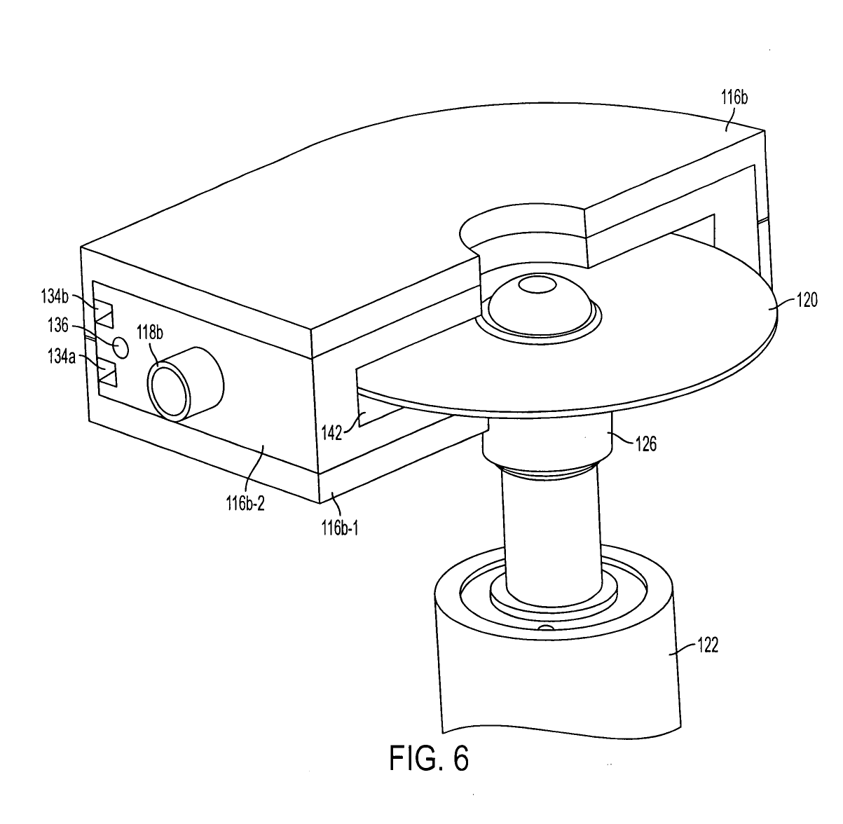

FIG. 6 is a simplified schematic diagram illustrating a portion of an exemplary heated drying stage in accordance with one embodiment of the invention. Enclosure 116b includes an outer portion 116b-1 and an inner portion 116b-2. Within inner portion 116b-2, cavity 142 is defined wherein the heated drying will take place. It should be appreciated that enclosure 116b will mate with a corresponding enclosure to substantially encapsulate substrate 120. Heated fluid is provided through inlet 118b. Substrate 120 is supported through collet 126 and rotation as well as vertical translation is provided through spindle 122. Cavities 134a and 134b extend along the outer perimeter of the inner portion 116b-2 and are eventually connected as will be illustrated below. In one embodiment, cavities 134a and 134b may provide vacuum to remove fluid provided through inlet 118b. Of course, cavities 134a and 134b may be used to include resistive heating elements to further heat the fluid being provided to inlet 118b.

The material for inner portion 116b-2 is a conductive material, such as stainless steel, etc., so that heat provided through any resistive heating element, or other heating elements, will conduct and heat the fluid entering through inlet 118b. In one embodiment, the fluid entering through inlet 118b will proceed in a serpentine manner in order to maximize the residence time to further heat the fluid. Inlet 136 may be used for a thermocouple to monitor the temperature of the fluid within the inner portion 116b-2. Alternatively, inlet 136 may be used to be connected to a vacuum source in order to provide removal of the fluid from inlet 118b. Outer portion 116b-1 is an insulative material, such as a porcelain material that does not conduct heat in order to efficiently provide heating for the fluid entering through inlet 118b.

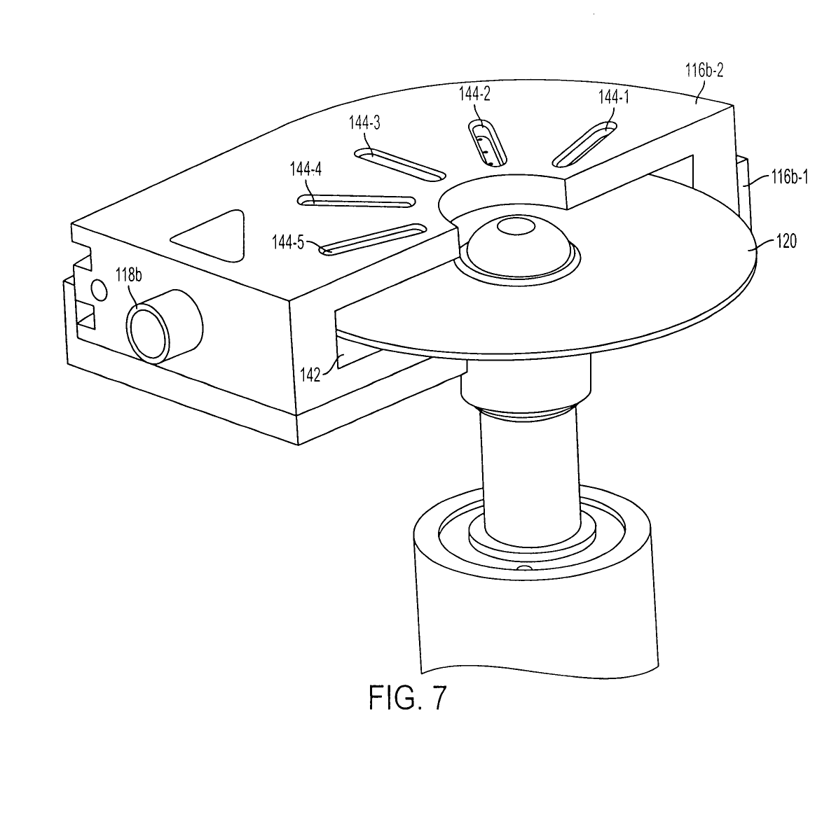

FIG. 7 is a simplified schematic diagram providing a perspective view of the enclosure for the final cleaning stage of the post sputter wash process module in accordance with one embodiment of the invention. Inner portion 116b-2 is provided with the outer portion 116b-1 removed from the top surface. Within a top surface of inner portion 116b-2, a number of slots 144-1 through 144-5 are provided. In each of slots 144-1 through 144-5 have apertures extending through the surface of inner portion 116b-2. As illustrated, slots 144-1 through 144-5 extend radially over the surface of the substrate. In one embodiment, four apertures are provided in each of slots 144-1 through 144-5. Of course, any number of apertures may be provided within slots 144-1 through 144-5.

In addition, while FIG. 7 illustrates five slots, any number of slots may be used. Apertures within each of slots 144-1 through 144-5 extend so that heated fluid will be projected onto a top surface of substrate 120. It should be appreciated that a bottom surface of inner portion 166b-2 will have similarly placed slots and apertures so that the bottom surface of substrate 120 will experience the projected heated fluid also. It should be further appreciated that the fluid may proceed through a serpentine path into slots 144-1 through 144-5 to be further heated as described above. As mentioned above, substrate 120 will spin as the heated fluid is projected onto the surface of substrate 120 in order to remove a final monolayer of fluid that remains after the high speed spin in the second cleaning level of the process module.

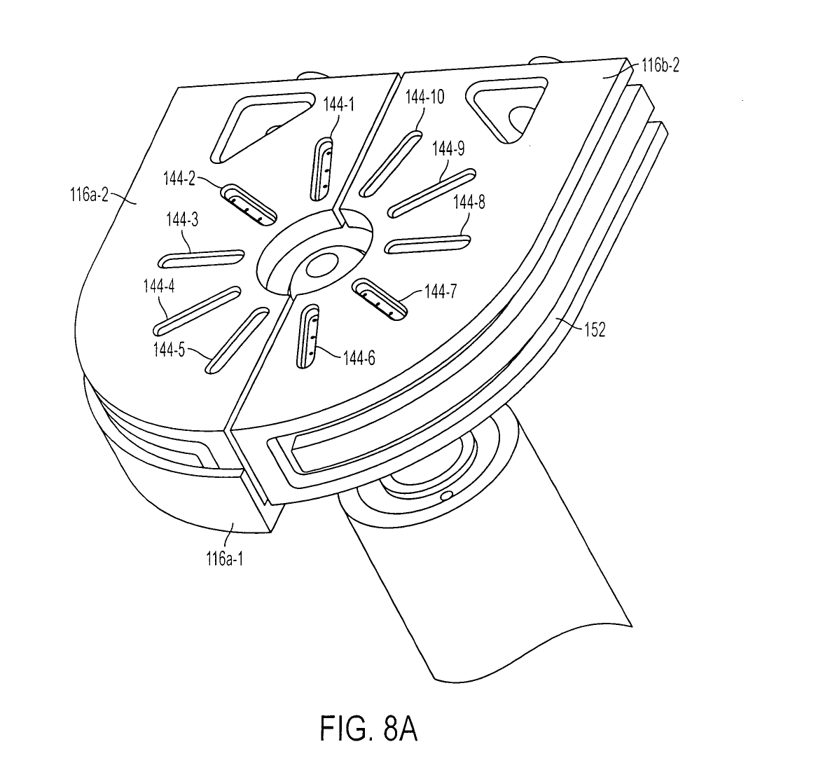

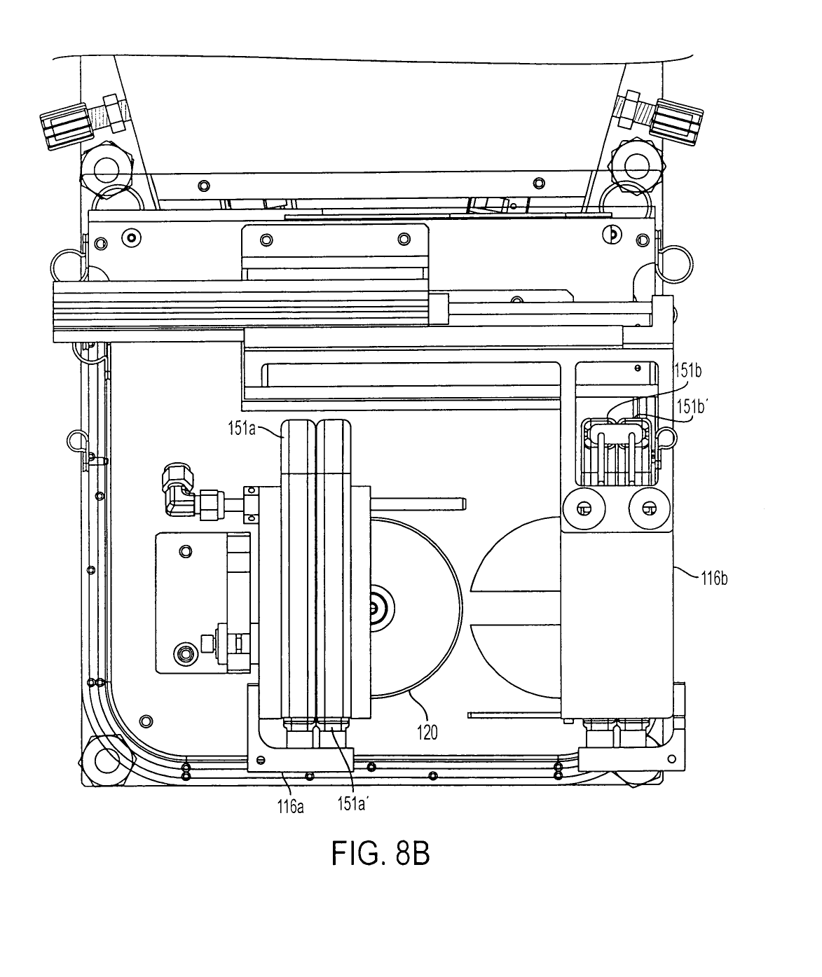

FIG. 8A is a simplified schematic diagram illustrating the perspective view of the enclosure for heating and drying the substrate in the post sputter wash process module in accordance with one embodiment of the invention. Inner portion 116b-2 is illustrated mated with inner portion 116a-2. In one embodiment, the gap between the two portions is approximately 1/50,000^{th} of an inch. As illustrated, on top of inner portion 116a-2 are slots 144-1 through 144-5. On top of inner portion 116b-2 are disposed slots 144-6 through 144-10. Likewise, on the bottom surfaces of inner portions 116b-2 and 116a-2 a similar number and located slots will be provided in order to uniformly project heated fluid onto the surface of the substrate as the substrate is spinning within the cavity defined between the mated inner portions. Extending along an outer surface of inner portion 116b-2 is a cavity 152. As mentioned above, cavity 152 may be used for resistive heating elements or in the alternative to remove fluid through vacuum provided to this cavity. Of course, cavity 152 may simply be an exhaust cavity where vacuum does not necessarily have to be provided.

FIG. 8B is a top view of another embodiment of the enclosure for heating and drying the substrate in the post sputter wash process module in accordance with one embodiment of the invention. Though illustrated in an open position, FIG. 8B illustrates the use of resistive heating elements 151a, 151a′, 151b and 151b′ to heat and dry the substrate 120. In one embodiment, the heating elements 151a and 151a′ are associated with the enclosure 116a while heating elements 151b and 151b′ are associated with the enclosure 116b. As illustrated, the heating elements 151a and 151a′ are positioned to heat the top surface of the substrate 120. When enclosures 116a and 116b are in a closed position, heating elements 151b and 151b′ are positioned to heat the bottom surface of the substrate 120. In one embodiment, when resistive heating elements such as infrared quartz is used, the interior surfaces of the enclosures 116a and 116b reflect radiant or heat energy to inhibit heat dissipation and improve heating of the substrate surface. While FIG. 8B illustrates using dual heating elements to encompass approximately half of the substrate, this should not be considered limiting. In other embodiments additional or fewer heating elements may be used to effectuate heating and drying of various sized substrates.

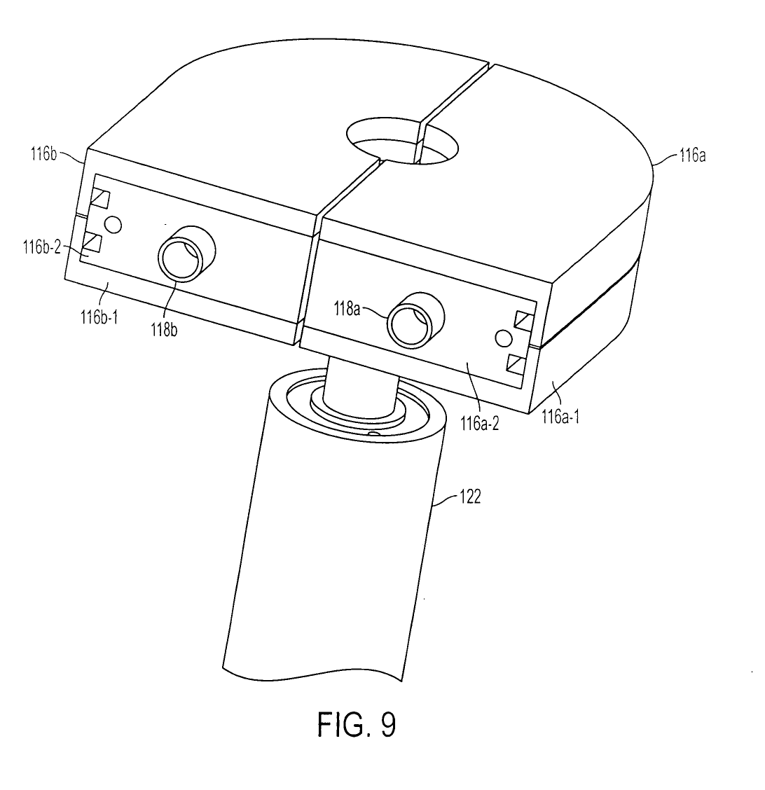

FIG. 9 is a simplified schematic diagram illustrating a rear perspective view of the enclosure for the heated fluid drying of the third stage of the post sputter wash process module in accordance with one embodiment of the invention. As illustrated, inlet ports 118a and 118b provide heated fluid from a heated fluid source. In one embodiment, the heated fluid is an inert gas such as nitrogen, argon, helium, etc. Any suitable gas compatible with the substrate and nature of operations being provided that will remove a monolayer of fluid from the surface of a substrate may be provided through the inlet ports. Inner portions 116a-2 and 116b-2 are also shown within outer portions 116a-1 and 116b-1. Spindle 122 will support and rotate the substrate within the cavity defined between the enclosure.

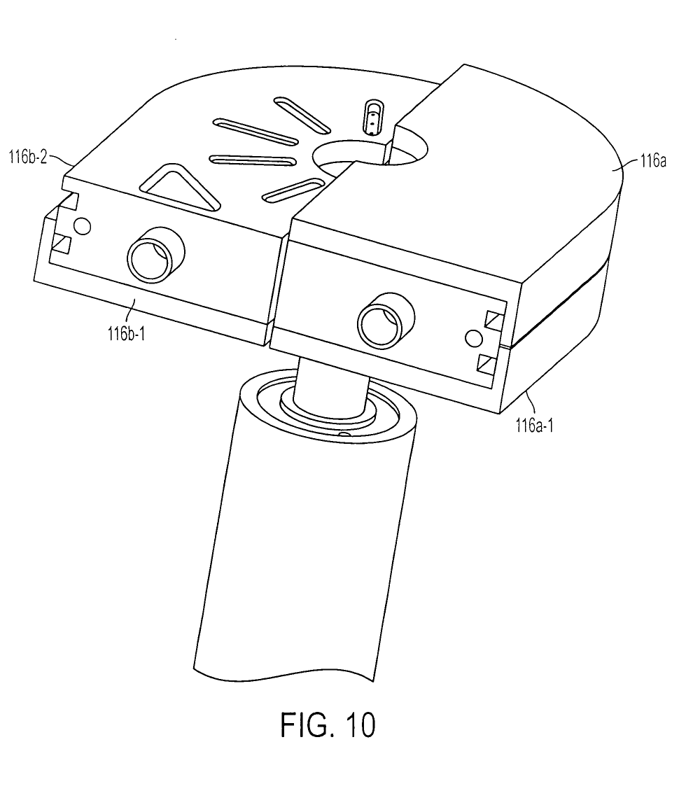

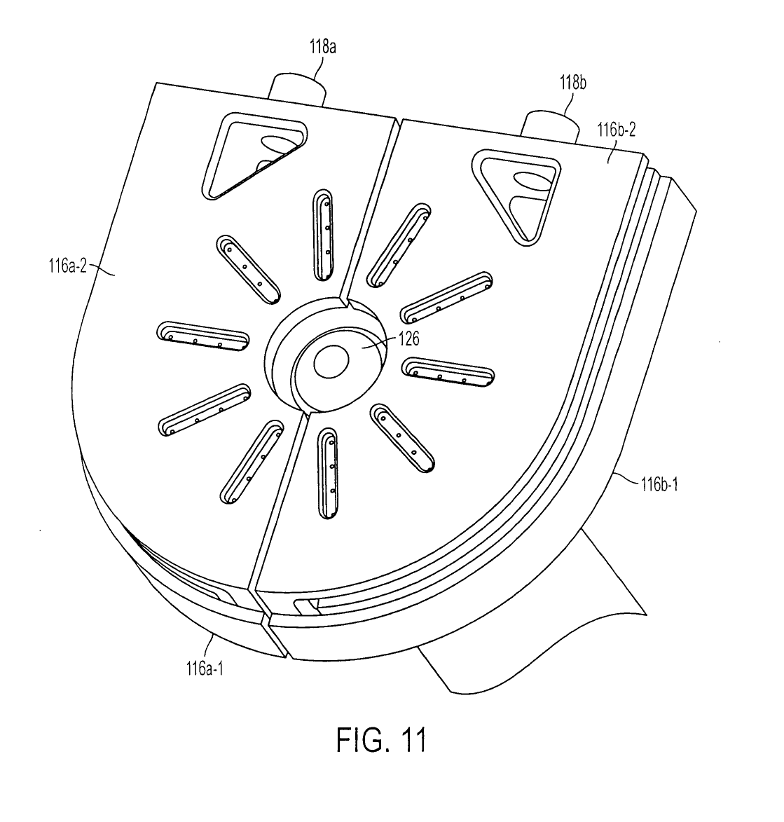

FIGS. 10 through 12 provide alternative views of the final stage for the post sputter wash process module in accordance with one embodiment of the invention. These figures further illustrate the distribution of the process gas into the enclosures so that the substrate may be dried efficiently. For example, in FIG. 10 illustrates the final stage for the post sputter wash process module with enclosure 116b removed revealing inner portion 116b-2 It should be appreciated that the small cavity provided inside of the enclosures for the final heating stage enables the process to be performed quickly so that throughput is not impacted for the single wafer cleaning process described herein. In FIG. 11, the top portion of collet 126 is illustrated while portions of the enclosure have been removed to expose inner portions 116a-2 and 116b-2. It should be appreciated that collet 126 is constructed of a material that will expand to grip the inner hole of the substrate being washed that will not be effected by the high processing temperature taking place within the heated chamber.

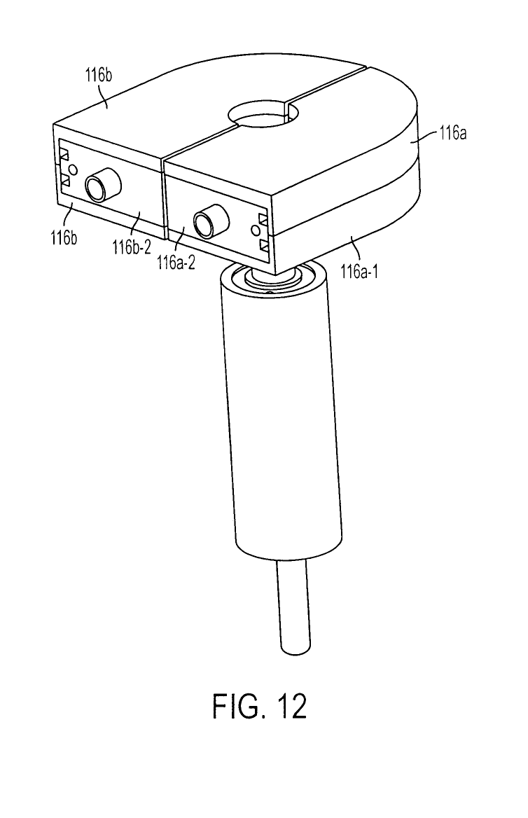

FIG. 12 illustrates inner portions 116a-2 and 116b-2 within outer portions 116a-1 and 116b-2 and enclosures 116a and 116b. In other embodiment, enclosure 116a can remain stationary while enclosure 116b is translated between an open and closed position. An example of such an embodiment can be seen in FIG. 2A-1. In FIG. 2A-1 enclosure 116b is shown in an open position to allow the substrate to be raised into the third chamber that will be formed when enclosure 116b is translated into a closed position. Exemplary materials for collet 126 may include insulative type of materials having a low heat coefficient or coefficient of expansion.

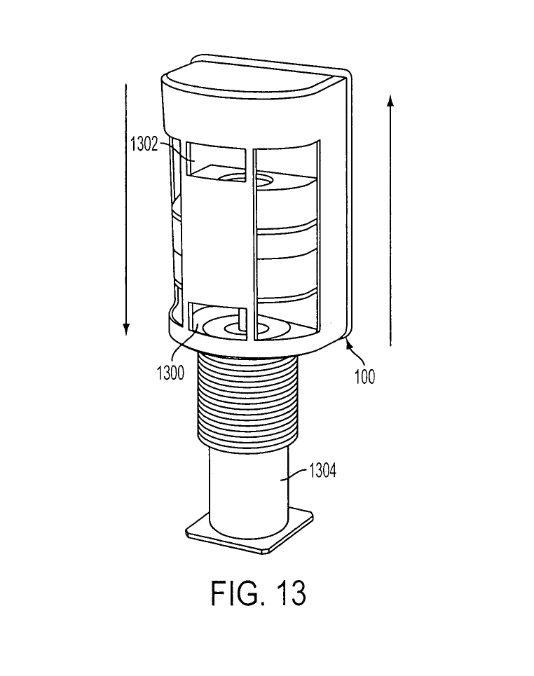

FIG. 13 is a simplified schematic diagram illustrating an alternative embodiment of the invention where the post sputter wash module 100 includes a bottom port 1300 and a top port 1302. In this embodiment, a substrate to be cleaned may be inserted through the bottom inlet 1300 port and removed upon completion of the cleaning through the top port 1302. Here, the cleaner 100 may move and the spindle 1304 remains at a constant height in this embodiment. Therefore, the robot load height will be constant where different input ports may be used but the same height and the same end effector are provided for removal and insertion of the substrate into the cleaning module. It should be appreciated that the embodiment described with regard to FIG. 13 provides for the cascade cleaning effect, i.e., the substrate transitions from a less clean environment to a cleaner environment, similar to the embodiments described above with regard to FIGS. 1 through 12.

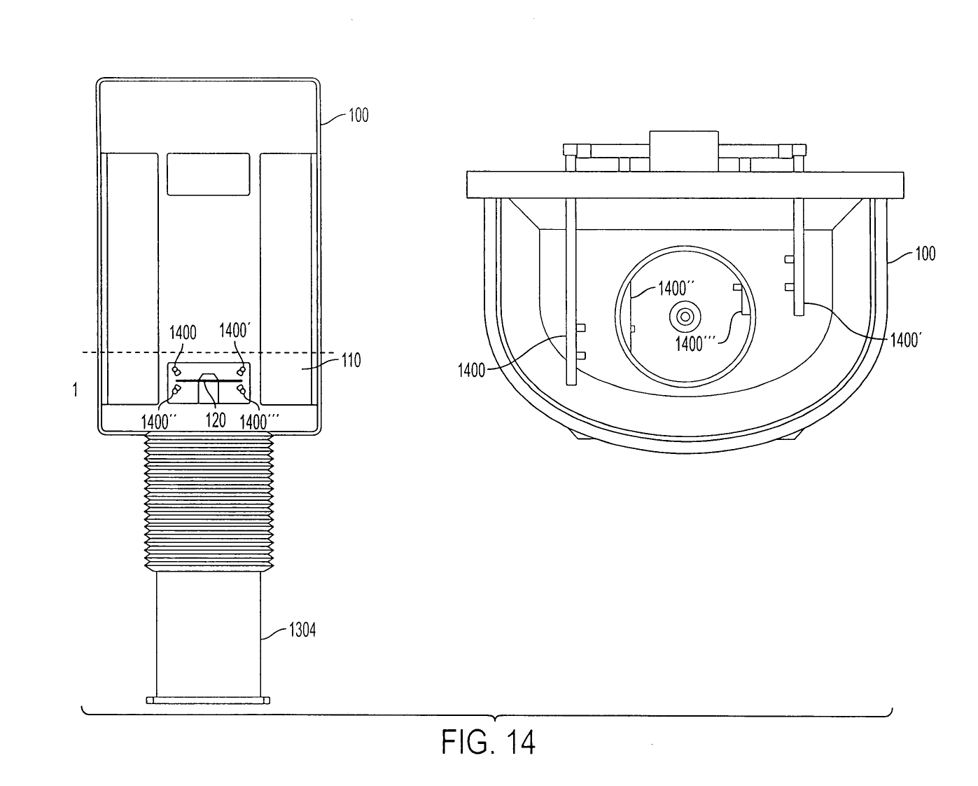

FIG. 14 illustrates a simplified schematic diagram of the substrate being positioned into the first cleaning stage 110 for a rinse operation in accordance with one embodiment of the invention. As illustrated in FIG. 14, nozzles 1400, 1400′, 1400″ and 1400′″ are disposed above and below the substrate 120 in order to clean top and bottom surface of the substrate 120 while the substrate 120 spins. In addition, the nozzles 1400, 1400′, 1400″ and 1400′″ are on extension arms (not shown) which are retractable in order to provide movement of either the spindle 1304 or the entire housing 100 depending on which configuration is used. For example, within FIG. 14, top nozzles 1400 and 1400′ are shown in an open position while bottom nozzles 1400″ and 1400′″ which are illustrated below the substrate 120 are shown in a closed or retracted position.

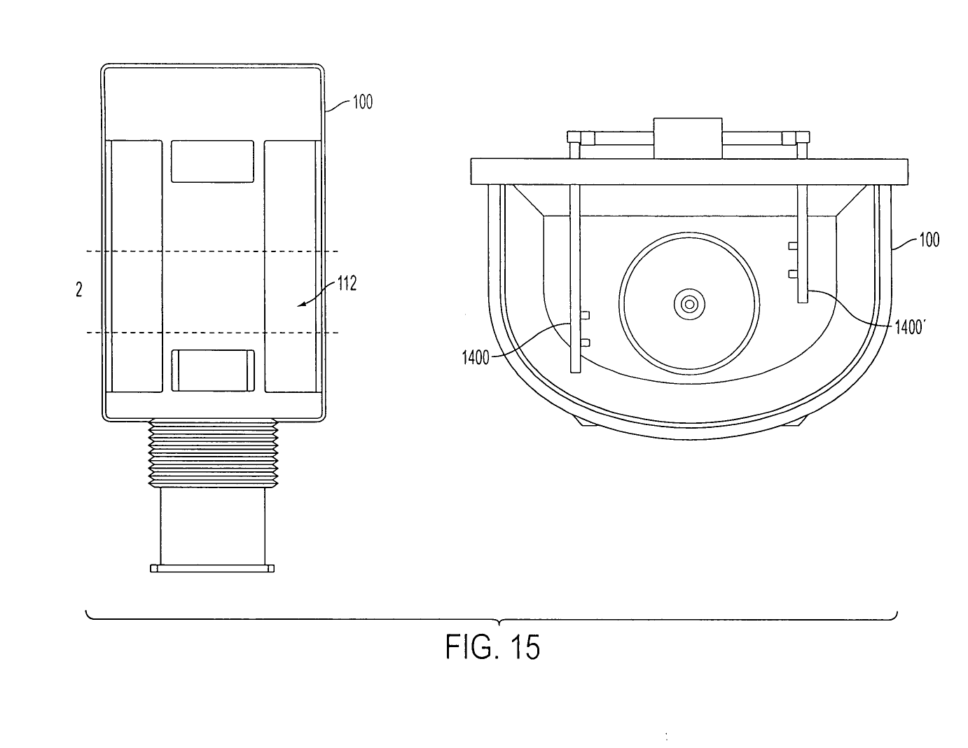

FIG. 15 illustrates a next position in which the housing 100 has dropped down, i.e., the bellows has further compressed in order to provide the spin dry position 112 in the next level of cleaning. Here, the progressive drying proceeds with a spin rate of approximately 10,000 rpm. As illustrated in FIG. 15, the nozzles 1400 and 1400′ are retracted in order to enable movement of either the spindle with the substrate 120, or the housing 100 itself.

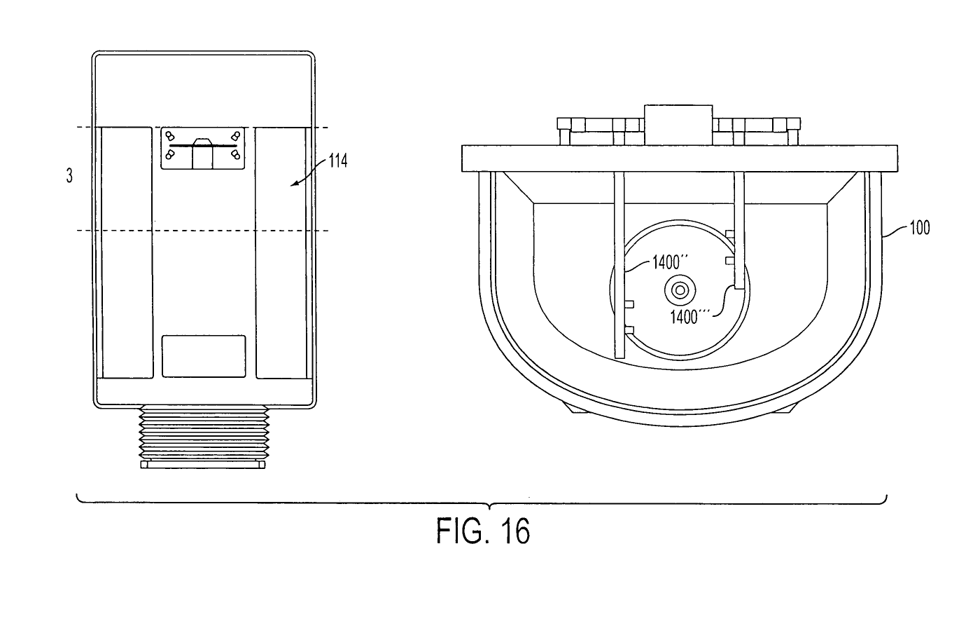

FIG. 16 is a simplified schematic diagram illustrating the further retraction of the bellows so that the housing 100 drops to a third level 114 in order for the heated drying process to proceed. In this embodiment, the nozzles 1400″ and 1400′″ are provided to heat the surface of the substrate without the enclosure. Of course, the enclosure can be used as illustrated above in which the enclosure retracts and opens in this embodiment. One skilled in the art will appreciate that nozzles spraying heated fluid or retractable heating elements may also be used alternatively.

Thus, the embodiments described herein provide for a system and method for cleaning and drying a substrate. In the method, the substrate is dried within a single post sputter wash process module. The method would initiate with delivering a substrate, such as a magnetic disk into the post sputter wash process module. In the first cleaning level of the post sputter wash process module, both sides of the substrate will be sprayed with a cleaning fluid such as deionized water while spinning in order to remove any carbon flakes or other contaminants from the sputter process recently experienced by the substrate. The substrate is then transitioned to a next level within the process module in order to experience a next level of cleaning. The next level of cleaning will include spinning the substrate at a high spin rate. For example, the spin rate at the lower level may be 2000 rpm in one embodiment, while the spin rate at the higher level may be 10,000 rpm.

One skilled in the art will appreciate that as the substrate is moving from the first level to the second level, the spin rate may be ramped up so that when the substrate is at the second level, the spin rate may already be at 10,000 rpm. Upon completion of the spin operation at the second level, the substrate is transitioned to a third level where the substrate is encapsulated through two enclosures and a heated fluid is provided within a cavity defined by the two enclosures surrounding the spinning substrate. The heated drying completes and the enclosures retract to enable removal of the substrate from the post sputter wash process module. In one embodiment, the heated fluid is provided at a rate of approximately 50 liters per minute and at a temperature of 150° C. In yet another embodiment, the heated fluid is further heated within the retractable enclosures to a temperature of 250° C. to efficiently remove a final monolayer of cleaning fluid on the surfaces of the substrate. As described above, exhaust of vacuum may be provided for the wet process operations in the first and second level and separately for the heated processing at the third level. One skilled in the art will appreciate that numerous vacuum configurations may be provided within the scope and spirit of the embodiment.

Of course the module described herein may be combined with a plurality of such modules for an automated tool which will provide the throughput desired. The automated tool will have automated delivery through conveyor operations in order to minimize any risk of contamination. One skilled in the art will appreciate that numerous configurations for an automated tool based on the post sputter wash process module described herein may be constructed. Exemplary claims are also provided which are not meant to be limiting. The exemplary claims are provided in order to illustrate certain embodiments of the invention.

Any of the operations described herein that form part of the invention are useful machine operations. The invention also relates to a device or an apparatus for performing these operations. The apparatus can be specially constructed for the required purpose, or the apparatus can be a general-purpose computer selectively activated, implemented, or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for cleaning a substrate in a cleaning module, comprising method operations of:
receiving the substrate into a first level of the cleaning module;
spinning the substrate while contemporaneously applying a cleaning fluid to top and bottom surfaces of the substrate;
spinning the substrate at a second level of the cleaning module; and
drying the substrate in an enclosed cavity at a third level of the cleaning module.

2. The method of claim 1, wherein the method operation of spinning the substrate while contemporaneously applying a cleaning fluid to top and bottom surfaces of the substrate is performed at a lower spin rate than the spinning at the second level.

3. The method of claim 1, wherein the method operation of receiving the substrate into a first level of the cleaning module includes gripping the substrate through an inner hole of the substrate.

4. The method of claim 1, wherein the substrate is raised to each level.

5. The method of claim 1, wherein the cleaning module is lowered while the substrate stays at a constant vertical position.

6. The method of claim 1, wherein the method operation of drying the substrate in an enclosed cavity at a third level of the cleaning module includes flowing a heated fluid over a top and a bottom surface of the substrate.

7. The method of claim 1, wherein drying the substrate in an enclosed cavity at a third level of the cleaning module includes,
retracting portions of an enclosure defining the enclosed cavity;
raising the substrate;
enclosing the portions around the substrate; and
spinning the substrate while heating the substrate.

8. A cleaning module, comprising:
an enclosure in which multiple cleaning levels are provided, the enclosure including,
a lower inner enclosure configured to accommodate a wet cleaning operation,
a middle partial enclosure wherein a spinning operation of a substrate being cleaned is performed; and
an upper enclosure configured to close around the substrate, the upper enclosure configured to dry the substrate at an elevated temperature.

9. The cleaning module of claim 8, further comprising:
a spindle for gripping and rotating the substrate, the spindle configured to vertically traverse a path between each of the lower inner enclosure, the middle partial enclosure and the upper enclosure.

10. The cleaning module of claim 8, wherein the upper enclosure includes an inlet port for receiving a heated drying fluid.

11. The cleaning module of claim 8, wherein the upper enclosure includes a heating element to elevate a temperature of a drying fluid flowing therein.

12. The cleaning module of claim 8, wherein the upper enclosure includes a plurality of slots radially opposing top and bottom surfaces of the substrate, the plurality of slots enabling access for a drying fluid to the top and bottom surface of the substrate.

13. The cleaning module of claim 8, wherein the lower enclosure is conically shaped.

14. The cleaning module of claim 8, wherein the lower enclosure includes retractable nozzles opposing both a top surface and a bottom surface of the substrate.

15. The cleaning module of claim 8, wherein the upper enclosure includes a conductive inner portion substantially enclosed by an insulative outer portion.

16. The cleaning module of claim 14, wherein the retractable nozzles apply a fluid having acoustic energy.

17. A cleaning apparatus for a substrate, comprising:
a first chamber being configured to apply a rinse agent to the substrate;
a second chamber being configured to perform an ambient temperature drying operation; and
a third chamber being configured to perform an elevated temperature drying operation.

18. The cleaning apparatus of claim 17, further comprising:
a transport assembly being configured to secure and spin the substrate, the transport apparatus also configured to traverse a linear path between the first, second and third chambers.

19. The cleaning apparatus of claim 18, wherein the rinse agent is applied to the substrate through multiple nozzles.

20. The cleaning apparatus of claim 18, wherein the transport assembly spins the substrate as the rinse agent is applied.

21. The cleaning apparatus of claim 17, wherein the third chamber includes a heating element.

22. The cleaning apparatus of claim 17, wherein a vacuum is drawn within the second chamber during the ambient temperature drying operation.

23. A substrate cleaned by process operations, comprising:
securing the substrate to a collet affixed to a spindle;
spinning the substrate while applying a cleaning fluid to top and bottom surfaces of substrate;
extending the spindle to transition the substrate from a first chamber to a second chamber of the substrate cleaning assembly;
spinning the substrate within the second chamber of the substrate cleaning assembly;
extending the spindle to transition the substrate from the second chamber into a third chamber of the substrate cleaning assembly; and
heating the substrate while spinning the substrate within the third chamber.

24. The substrate cleaned by process operations of claim 23, wherein the spin rate within the second chamber is higher than the spin rate within the first chamber.

25. The substrate cleaned by process operations of claim 23, wherein heating elements within the third chamber are used to heat the substrate.

26. The substrate cleaned by process operation of claim 25, wherein interior surfaces of the third chamber are configured to reflect heat energy.
